(19) United States
(12) Patent Application Publication
(10) Pub. No.: US 2018/0267903 A1
(43) Pub. Date: Sep. 20, 2018

(54) MEMORY SYSTEM AND OPERATING METHOD THEREOF

(71) Applicant: SK hynix Inc., Gyeonggi-do (KR)

(72) Inventor: Su-Hyuck NO, Seoul (KR)

(21) Appl. No.: 15/727,813

(22) Filed: Oct. 9, 2017

(30) Foreign Application Priority Data
Mar. 14, 2017 (KR) 10-2017-0031666

(51) Int. Cl. G06F 12/14; G06F 3/06; H04L 9/08; G06F 12/02

(52) U.S. Cl. CPC G06F 12/1408; G06F 3/0623; G06F 3/064; G06F 3/068; H04L 9/0618; H04L 9/0819; G06F 12/0246; G06F 2212/1052; H04L 9/0869

(57) ABSTRACT

A memory system includes: a controller suitable for generating a control signal for changing a data output status of a memory device to an abnormal status; and the memory device suitable for, when the data output status is the abnormal status, changing second data, which correspond to a read command from the controller among first data stored therein, into encrypted data, and outputting the encrypted data.

### CROSS-REFERENCE TO RELATED APPLICATIONS

The present application claims priority of Korean Patent Application No. 10-2017-0031666, filed on Mar. 14, 2017, which is incorporated herein by reference in its entirety.

### BACKGROUND

### 1. Field

Various exemplary embodiments of the present invention relate to a memory system and operating method thereof.

### 2. Description of the Related Art

FIGS. 1 to 3 are block diagrams illustrating a conventional memory system including a controller operatively coupled to a plurality of memories.

FIG. 1 is a block diagram illustrating a conventional memory system 101 including a controller 111 and volatile memories 121 and 131. In order to implement a memory system of a high capacity, the conventional memory system 101 includes a plurality of volatile memories 121 and 131. The volatile memory is relatively expensive, and thus the cost of the conventional memory system 101 rises as the existing memory system 101 includes more volatile memoires.

FIG. 2 is a block diagram illustrating a conventional memory system 102 including a controller 112, volatile memories 122 and 132 and a non-volatile memory 142.

The existing memory system 102 includes the non-volatile memory 142, which is relatively cheaper than the volatile memory, and thus the high capacity can be achieved with a relatively lower cost for the conventional memory system 102. However, the non-volatile memory can retain data even when the memory system 102 is powered off, which is different from the volatile memory, and thus a malicious user can obtain data retained in the non-volatile memory. That is, a malicious user can access operation data of a host, which is retained in the non-volatile memory.

FIG. 3 is a block diagram illustrating an existing memory system 103 including a controller 113, volatile memories 123 and 133, a non-volatile memory 143 and an encrypt unit 153. The encrypt unit 153 stores data, which is provided from the controller 113, into the non-volatile memory 143 after encryption of the provided data. Also, the encrypt unit 153 provides data, which is stored in the non-volatile memory 143, to the controller 113 after decryption of the stored data. That is, the conventional memory system 103 requires the encryption and decryption operations for data communication between the non-volatile memory 143 and the controller 113, and the encryption and decryption operations cause delay of data communication between the non-volatile memory 143 and the controller 113. Further, the encrypt unit 153 causes the cost rise of the conventional memory system 103.

### SUMMARY

Various embodiments of the present invention are directed to a memory system capable of securing data stored in a non-volatile memory without delay of data communication between a controller and the non-volatile memory.

In accordance with an embodiment of the present invention, a memory system may include a controller suitable for generating a control signal for changing a data output status of a memory device to an abnormal status; and the memory device suitable for, when the data output status is the abnormal status, changing second data, which correspond to a read command from the controller among first data stored therein, into encrypted data, and outputting the encrypted data.

The controller may generate the control signal when a sudden power off (SPO) occurs in the memory system.

The memory device may further change a register value representing the data output status to a value representing the abnormal status in response to the control signal.

The encrypted data may be a result of XOR operation to the second data and a random key.

The memory device may be a non-volatile memory device.

The memory device may further perform an erase operation to the first data when the data output status becomes the abnormal status.

The memory device may further change the data output status to a normal status upon completion of the erase operation.

In accordance with an embodiment of the present invention, An operating method of a memory system, the operating method may include: generating, by a controller, a control signal for changing a data output status of a memory device to an abnormal status; and changing, by the memory device when the data output status is the abnormal status, second data, which correspond to a read command from the controller among first data stored in the memory device, into encrypted data, and outputting the encrypted data.

The control signal may be generated when a sudden power off (SPO) occurs in the memory system.

It may further include changing a register value representing the data output status to a value representing the abnormal status in response to the control signal.

The encrypted data may be result of XOR operation to the second data and a random key.

The memory device may be a non-volatile memory device.

It may further include performing, by the memory device when the data output status becomes the abnormal status, an erase operation to the first data.

It may further include changing, by the memory device, the data output status to a normal status upon completion of the erase operation.

In accordance with various embodiments of the present invention, data stored in a non-volatile memory may be secured without delay of data communication between a controller and the non-volatile memory.

### BRIEF DESCRIPTION OF THE DRAWINGS

These and other features and advantages of the present invention will become apparent to those skilled in the art to which the present invention pertains from the following detailed description in reference to the accompanying drawings in which:

FIG. 1 is a block diagram illustrating a conventional memory system including a controller and volatile memories;

FIG. 2 is a block diagram illustrating a conventional memory system including a controller, volatile memories and a non-volatile memory;

FIG. 3 is a block diagram illustrating a conventional memory system including a controller, volatile memories, a non-volatile memory and an encrypt unit;

FIG. 4 is a block diagram illustrating a memory system in accordance with an embodiment of the present invention;

FIG. 5A is a block diagram illustrating an exemplary configuration of a memory device shown in FIG. 4.

FIG. 5B is a circuit diagram illustrating an exemplary configuration of a memory cell array of a memory block in the memory device shown in FIG. 4;

FIG. 5C is a schematic diagram illustrating a structure of the memory device shown in FIG. 4;

FIG. 6 is a flow chart illustrating an operation of a memory system in accordance with an embodiment of the present invention;

FIG. 7 is a flow chart illustrating an operation of a memory system in accordance with an embodiment of the present invention; and

FIG. 8 is a block diagram illustrating a memory system in accordance with an embodiment of the present invention.

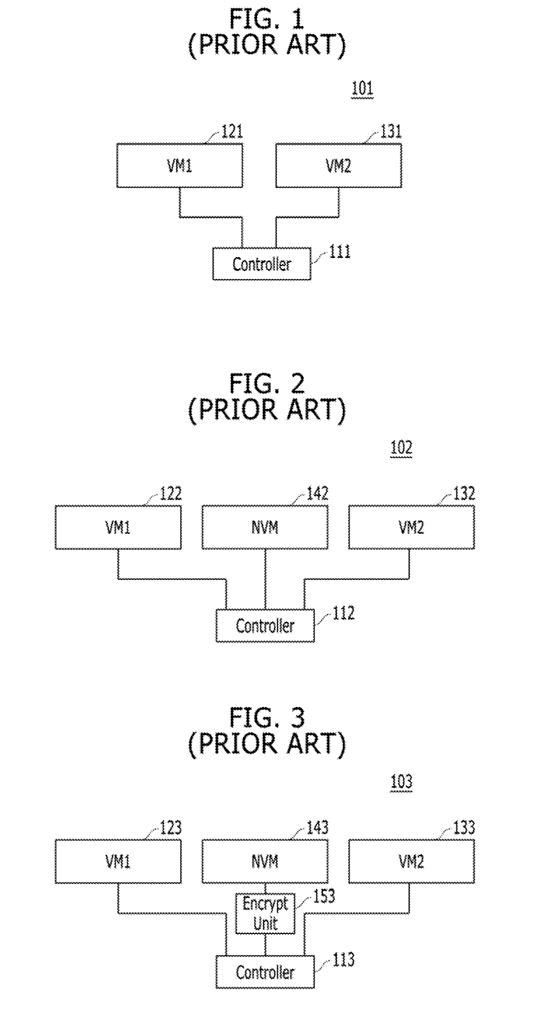

### DETAILED DESCRIPTION

Various embodiments of the present invention are described below in more detail with reference to the accompanying drawings. We note, however, that the present invention may be embodied in different other embodiments, forms and variations thereof and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention.

As used herein, singular forms are intended to include the plural forms as well, unless the context clearly indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. However, it is noted that the present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

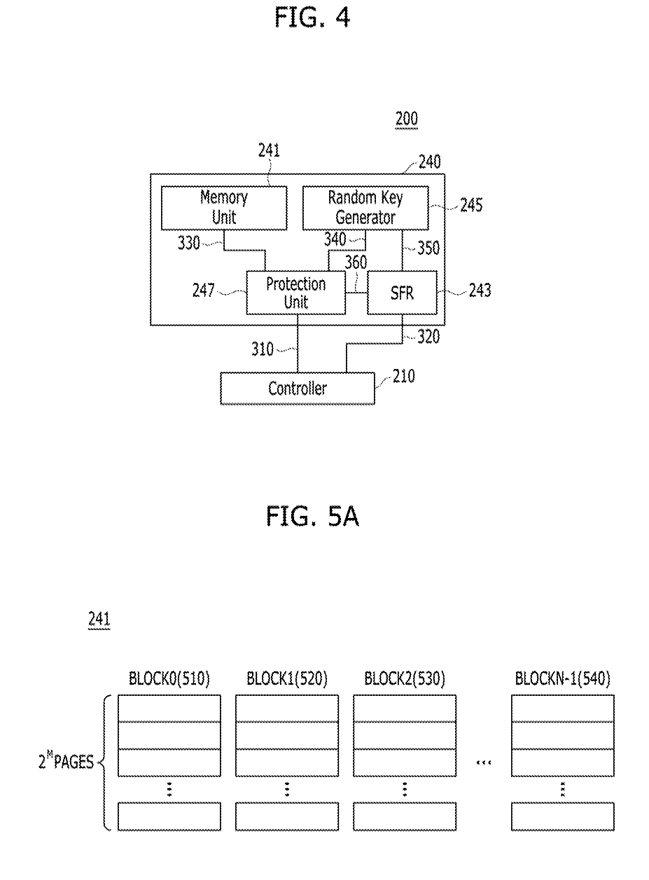

FIG. 4 is a block diagram illustrating a memory system 200 in accordance with an embodiment of the present invention.

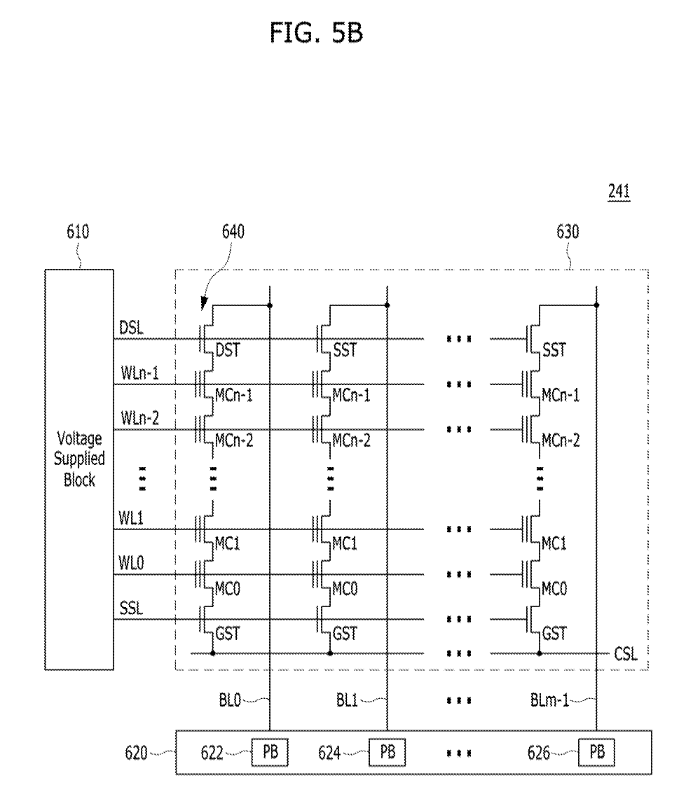

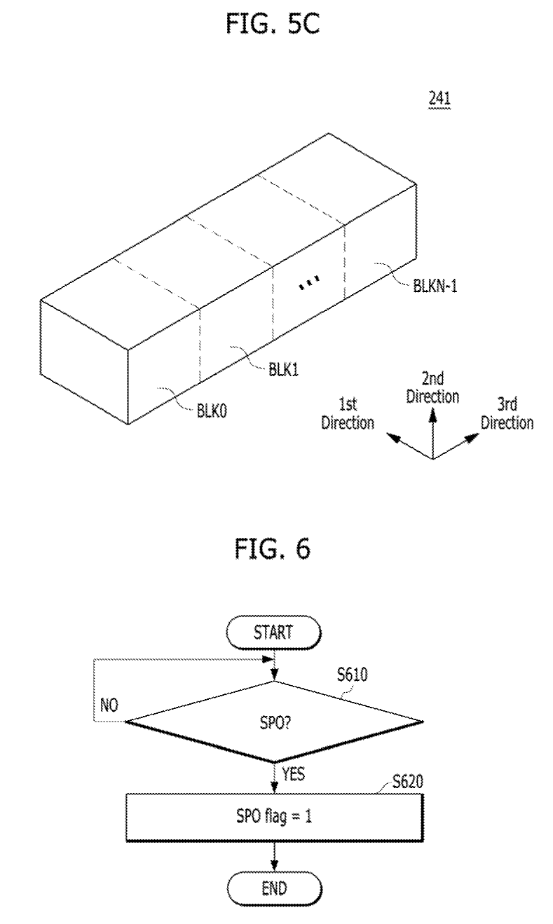

FIG. 5A is a block diagram illustrating a memory device 240 shown in FIG. 4.

FIG. 5B is a circuit diagram illustrating an exemplary configuration of a memory cell array of a memory block in the memory device 240.

FIG. 5C is a schematic diagram illustrating a structure of the memory device 240.

Referring to FIG. 4, the memory system 200 may include a controller 210 and the memory device 240. The memory device 240 may be a non-volatile memory device. Data and control signal may be transferred between the controller 210 and the non-volatile memory device 240 through first and second lines 310 and 320.

The controller 210 may control the non-volatile memory device 240 and perform data communication with the non-volatile memory device 240 through the first line 310. The controller 210 may provide data and a corresponding write command to the non-volatile memory device 240 through a first path of the first line 310. The controller 210 may provide a read command to the non-volatile memory device 240 through the first path of the first line 310, and may receive read data, which is provided from the non-volatile memory device 240 in response to the read command, through a second path of the first line 310. The first line 310 may include a control bus and a data bus. The control bus may transfer a command and an address between the controller 210 and the non-volatile memory device 240. The data bus may transfer data between the controller 210 and the non-volatile memory device 240. The control bus may include a line for transferring a clock CK and a line for transferring a clock enable signal CKE, which indicates an operation timing point of the non-volatile memory device 240 in synchronization with the clock CK.

The controller 210 may control the non-volatile memory device 240 through the second line 320. The controller 210 may change register values of the non-volatile memory device 240 through the second line 320.

The controller 210 may be included in a processor such as a Central Processing Unit (CPU), a Graphic Processing Unit (GPU), an Application Processor (AP) and so forth. The controller 210 may be mounted on a memory module such as a dual in-line memory module (DIMM). The controller 210 may be implemented to be mounted on a separate chip in a system including a memory device such as, for example, a computing device, a mobile phone, and other electronic devices.

The non-volatile memory device 240 may include a memory unit 241, a Sudden power off Flag Register (SFR) 243, a random key generator 245 and a protection unit 247.

The memory unit 241 may retain data stored therein even though power is not supplied. The memory unit 241 may store data provided from the controller 210 through a write operation, and provide data stored therein to the controller 210 through a read operation. The memory unit 241 may include a plurality of memory blocks. Each memory block may include a plurality of pages. In an embodiment, the memory unit 241 may be embodied with a flash memory. The flash memory may have a 3-dimensional (3D) stack structure.

Referring to FIG. 5A, the memory unit 241 may include a plurality of memory blocks 510, 520, 530 and 540, and each of the blocks 510, 520, 530 and 540 may include a plurality of pages, for example, 2^{M} pages. In another embodiment, each of the blocks 510, 520, 530 and 540 may include M pages. The pages may include a plurality of memory cells coupled to a plurality of corresponding word lines WLs.

The memory blocks included in the memory unit 241 may be classified into a single level cell (SLC) memory block and a multi-level cell (MLC) memory block depending on a number of bits that can be stored in a single memory cell in the memory blocks. The SLC memory block may include a plurality of pages each embodied by memory cells each storing 1-bit data. The SLC memory block may have high data computing performance and high durability. The MLC memory block may include a plurality of pages each embodied by memory cells each storing multi-bit data (for example, 2 or more bits). The MLC memory block may have a greater storage space than the SLC memory block, that is, higher integration density. The MLC memory block including a plurality of pages each embodied by memory cells each storing 3-bit data may be specially referred to as a triple level cell (TLC) memory block.

Each of the memory blocks 510, 520, 530 and 540 may store data provided from the controller 210 therein through a write operation, and may provide stored data to the controller 210 through a read operation.

Referring to FIG. 5B, a memory block 630 which may correspond to any of the plurality of memory blocks 510, 520, 530 and 540 included in the memory unit 241 of the memory system 200 may include a plurality of cell strings 640 coupled to a plurality of corresponding bit lines BL0 to BLm−1. The cell string 640 of each column may include one or more drain select transistors DST and one or more source select transistors SST. Between the drain and source select transistors DST and SST, a plurality of memory cells MC0 to MCn−1 may be coupled in series. In an embodiment, each of the memory cell transistors MC0 to MCn−1 may be embodied by an MLC capable of storing data information of a plurality of bits. Each of the cell strings 640 may be electrically coupled to a corresponding bit line among the plurality of bit lines BL0 to BLm−1.

Although FIG. 5B illustrates NAND flash memory cells, the invention is not limited in this way. For example, in an embodiment the memory cells may be NOR flash memory cells, and in an embodiment the memory cells may be hybrid flash memory cells including two or more kinds of memory cells combined therein. Also, it is noted that the memory unit 241 may be a flash memory device including a conductive floating gate as a charge storage layer or a charge trap flash (CTF) memory device including an insulation layer as a charge storage layer.

The memory unit 241 may further include a voltage supply unit 610 which provides word line voltages including a program voltage, a read voltage and a pass voltage to the word lines according to an operation mode. The voltage generation operation of the voltage supply unit 610 may be controlled by a control circuit (not illustrated). The voltage supply unit 610 may generate a plurality of variable read voltages in order to generate a plurality of read data. Under the control of the control circuit, the voltage supply unit 310 may select one of the memory blocks (or sectors) of the memory cell array, select one of the word lines of the selected memory block, and provide the word line voltages to the selected word line and the unselected word lines.

The memory unit 241 may include a read/write circuit 620 which is controlled by the control circuit and serve as one of a sense amplifier and a write driver depending on an operation mode. During a verification/normal read operation, the read/write circuit 620 may operate as a sense amplifier for reading data from the memory cell array. During a program operation, the read/write circuit 620 may operate as a write driver for driving bit lines according to data to be stored in the memory cell array. During a program operation, the read/write circuit 620 may receive from a buffer (not illustrated) data to be stored into the memory cell array, and drive bit lines according to the received data. The read/write circuit 620 may include a plurality of page buffers 622 to 626 respectively corresponding to columns (or bit lines) or column pairs (or bit line pairs), and each of the page buffers 622 to 626 may include a plurality of latches (not illustrated).

The memory unit 241 may be embodied by a 2D or 3D memory device. Specifically, as illustrated in FIG. 5C, the memory unit 241 may be embodied by a non-volatile memory device having a 3D stack structure. FIG. 5C is a perspective view of memory blocks of the memory unit 241 shown in FIG. 5B. Each memory block BLK may be realized in a 3D structure (or a vertical structure). For example, each memory block BLK may include structures that are extended in first to third directions, e.g., x, y and z directions. However, we note that FIG. 5C, illustrates only one example of a 3-D structure. Other configurations may also be employed in a 3-D structure comprising a plurality of memory blocks stacked in a 3-D structure wherein each memory block is a 2-D structure of a plurality of strings.

Each memory block BLK may include a plurality of NAND strings NS, each of which is extended in the second direction. Also, a plurality of NAND strings NS may be provided in the first direction and the third direction. Each of the NAND strings NS may be coupled to a bit line BL, at least one source selection line SSL, at least one drain selection line DSL, a plurality of word lines WL, at least one dummy word line DWL, and a common source line CSL.

In other words, each memory block BLK may be coupled to a plurality of bit lines BL, a plurality of source selection lines SSL, a plurality of drain selection lines DSL, a plurality of word lines WL, a plurality of dummy word lines DWL, and a plurality of common source lines CSL, thereby including a plurality of NAND strings NS. Also, a single NAND string NS may include a plurality of transistors since a plurality of NAND strings NS are coupled to a single bit line BL in each memory block BLK. In each NAND string NS, a source select transistor SST may be coupled to a corresponding bit line BL and drain select transistors DST may be coupled to a common source line CSL. Between the drain and source select transistors DST and SST in each NAND string NS, a plurality of memory cells MC0 to MCn−1 may be coupled in series. Therefore, each memory block BLK of the memory unit 241 may include a plurality of memory cells.

Referring back to FIG. 4, the memory unit 241 may perform data communication with the protection unit 247 through a third line 330. Particularly, the memory unit 241 may receive data from the protection unit 247 through a first path of the third line 330, and may provide data to the protection unit 247 through a second path of the third line 330. Accordingly, data read from the memory unit 241 may be provided to the controller 210 through the protection unit 247, and data from the controller 210 may be provided to the memory unit 241 through the protection unit 247.

The SPO flag register 243 may store abnormal status information of the memory system 200 (e.g., SPO information of the memory system 200). When a SPO occurs in the memory system 200, the controller 210 may change a value stored in the SPO flag register 243 from a first value (e.g., a value of “0”) representing a normal status to a second value (e.g., a value of “1”) representing an occurrence of SPO before remaining power of the memory system 200 is exhausted. Therefore, the non-volatile memory unit 240 may identify an occurrence of SPO in the memory system 200 by reading a value stored in the SPO flag register 243.

When the value of the SPO flag register 243 represents an abnormal status of the memory system 200, the controller 210 may change the value of the SPO flag register 243 by initializing the SPO flag register 243 so that the value of the SPO flag register 243 represents a normal status of the memory system 200. For example, the controller 210 may initialize the SPO flag register 243 by first erasing data stored in the memory unit 241 of the non-volatile memory device 240 and then by changing the value of the SPO flag register 243 to a value of “O”. Since data stored in the memory unit 241 is erased, the memory system 200 may prevent a malicious user from accessing data stored in the memory unit 241. The initialization of the SPO flag register 243 may be performed when the memory system 200 is powered on after the SPO.

The random key generator 245 may generate a random key and provide the random key to the protection unit 247 through a fourth line 340 when the value of the SPO flag register 243 represents an abnormal status of the memory system 200. The random key generator 245 may identify the value of the SPO flag register 243 which it receives through a fifth line 350.

The protection unit 247 may encrypt data read from the memory unit 241 and provide the encrypted data to the controller 210 when the value of the SPO flag register 243 represents an abnormal status of the memory system 200. The protection unit 247 may identify the value of the SPO flag register 243 which it receives through a sixth line 360.

The protection unit 247 may encrypt data read from the memory unit 241 by performing an XOR operation to the data read from the memory unit 241 and the random key generated by the random key generator 245.

FIG. 6 is a flow chart illustrating an operation of the memory system 200 in accordance with an embodiment of the present invention.

FIG. 6 shows an operation of changing the value of the SPO flag register 243 to a second value (e.g., a value of “1”) representing an occurrence of SPO when a SPO occurs in the memory system 200.

Referring to FIG. 6, when the controller 210 detects an abnormal status of the memory system 200 at step S610, the controller 210 may change the value of the SPO flag register 243 to the second value of “1” at step S620.

Particularly, upon powering on the memory system 200, the controller 210 may determine whether or not a SPO occurs in the memory system 200 at step S610.

The process may proceed to step S620 when the controller 210 determines that an SPO occurred in the memory system 200 (“YES” at step S610). When the controller 210 determines that an SPO did not occur in the memory system 200 (“NO” at step S610) the process may return to the start point.

At step S620, the controller 210 may change a value stored in the SPO flag register 243 from a first value (e.g., a value of “0”) representing a normal status to a second value (e.g., a value of “1”) representing an occurrence of SPO before remaining power of the memory system 200 is exhausted.

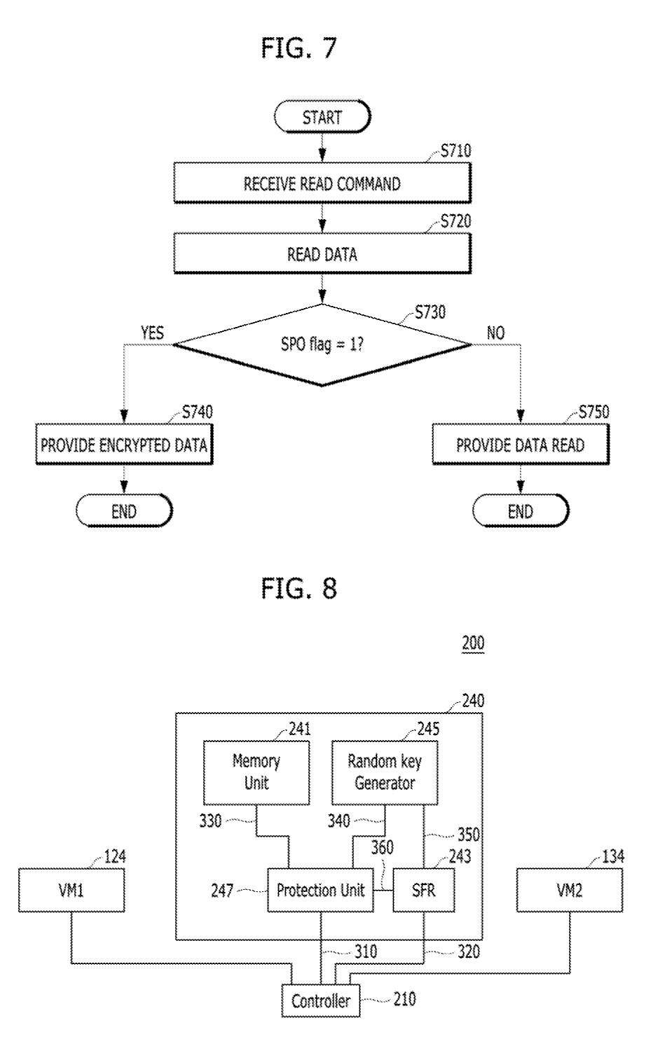

FIG. 7 is a flow chart illustrating an operation of the memory system 200 in accordance with an embodiment of the present invention.

FIG. 7 shows an operation of the non-volatile memory device 240 for securing the data stored in the memory unit by encrypting them when the memory system is powered on after an SPO. The memory system 200 secures the data which are stored in the memory unit 241 in response to a read command from the controller 210 when the value of the SPO flag register 243 represents an occurrence of an SPO in the memory system 200.

At step S710, the non-volatile memory device 240 may receive a read command from the controller 210.

At step S720, the non-volatile memory device 240 may read data from the memory unit 241 in response to the read command provided from the controller 210.

At step S730, the non-volatile memory device 240 may identify the value of the SPO flag register 243.

The process may proceed to step S740 when the value of the SPO flag register 243 is “1” representing an abnormal status of the memory system 200, and may proceed to step S750 when the value of the SPO flag register 243 is “0” representing a normal status of the memory system 200.

At step S740, the non-volatile memory device 240 may encrypt data read from the memory unit 241 by performing XOR operation to the data read from the memory unit 241 and the random key generated by the random key generator 245 through the protection unit 247, and may provide the encrypted data to the controller 210.

At step S750, the non-volatile memory device 240 may provide the controller 210 with data read from the memory unit 241.

As described above, in accordance with an embodiment of the present invention, the memory system 200 may secure data stored in the non-volatile memory device 240 without delay of data communication between the controller 210 and the non-volatile memory device 240, by performing data encryption locally within the non-volatile memory device 240.

FIG. 8 is a block diagram illustrating a memory system in accordance with an embodiment of the present invention.

The memory system 200 of FIG. 8 may be the same as the memory system 200 described with reference to FIGS. 4 to 7 except that a plurality of volatile memories 124 and 134 are further included in the memory system of FIG. 8. The volatile memories 124 and 134 may lose data stored therein when the memory system 200 is powered off. Therefore, the volatile memories 124 and 134 may not include the protection unit 247.

While the present invention has been described with respect to specific embodiments, it will be apparent to those skilled in the art that various changes and modifications may be made without departing from the spirit and scope of the invention as defined in the following claims.

What is claimed is:

1. A memory system comprising:
a controller suitable for generating a control signal for changing a data output status of a memory device to an abnormal status; and
the memory device suitable for, when the data output status is the abnormal status, changing second data, which correspond to a read command from the controller among first data stored therein, into encrypted data, and outputting the encrypted data.

2. The memory system of claim 1, wherein the controller generates the control signal when a sudden power off (SPO) occurs in the memory system.

3. The memory system of claim 2, wherein the memory device further changes a register value representing the data output status to a value representing the abnormal status in response to the control signal.

4. The memory system of claim 1, wherein the encrypted data is a result of XOR operation to the second data and a random key.

5. The memory system of claim 1, wherein the memory device is a non-volatile memory device.

6. The memory system of claim 1, wherein the memory device further performs an erase operation to the first data when the data output status becomes the abnormal status.

7. The memory system of claim 6, wherein the memory device further changes the data output status to a normal status upon completion of the erase operation.

8. An operating method of a memory system, the operating method comprising:
generating, by a controller, a control signal for changing a data output status of a memory device to an abnormal status; and
changing, by the memory device when the data output status is the abnormal status, second data, which correspond to a read command from the controller among first data stored in the memory device, into encrypted data, and outputting the encrypted data.

9. The operating method of claim 8, wherein the control signal is generated when a sudden power off (SPO) occurs in the memory system.

10. The operating method of claim 8, further comprising changing a register value representing the data output status to a value representing the abnormal status in response to the control signal.

11. The operating method of claim 8, wherein the encrypted data is a result of XOR operation to the second data and a random key.

12. The operating method of claim 8, wherein the memory device is a non-volatile memory device.

13. The operating method of claim 8, further comprising performing, by the memory device when the data output status becomes the abnormal status, an erase operation to the first data.

14. The operating method of claim 13, further comprising changing, by the memory device, the data output status to a normal status upon completion of the erase operation.
